(19) United States
(12) Patent Application Publication
(10) Pub. No.: US 2008/0075953 A1
(43) Pub. Date: Mar. 27, 2008

(54) Electrically Conductive Composites with Resin and Vgcf, Production Process, and Use Thereof

(75) Inventors: Yuji Nagao, Kanagawa (JP); Ryuji Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Tokyo (JP)

(21) Appl. No.: 11/661,130

(22) PCT Filed: Aug. 30, 2005
(86) PCT No.: PCT/JP05/16173

§ 371 Date: Feb. 26, 2007

Related U.S. Application Data
(60) Provisional application No. 60/607,593, filed on Sep. 8, 2004.
(60) Provisional application No. 60/607,594, filed on Sep. 8, 2004.

(30) Foreign Application Priority Data
Aug. 31, 2004 (JP) 2004-252526
Aug. 31, 2004 (JP) 2004-252543

(51) Int. Cl. C08L 101/00; C08J 3/20; H01B 1/24; H01B 13/00; C08K 7/06

(52) U.S. Cl. 428/339; 264/105

(57) ABSTRACT

Conductive composites with resin, produced by mixing a vapor grown carbon fiber having a fiber diameter of 2 to 500 nm with a matrix resin in a molten state while suppressing breakage of the fiber 20% or less, exhibit conductivity higher than that of a conventional conductive composites with resin through incorporation of vapor grown carbon fiber in an amount equivalent to a conventional amount, or exhibit conductivity equal to or higher than that of a conventional conductive composites with resin through incorporation of vapor grown carbon fiber in an amount smaller than a conventional amount. In the case where the melt-mixing of the fiber with resin is performed using a co-rotating twin-screw extruder, the vapor grown carbon fiber is preferably fed to the extruder by way of side feeding. In the case where the melt-mixing is performed using a pressure kneader, resin is sufficiently melted in the kneader in advance, and vapor grown carbon fiber is fed to the molten resin.

### CROSS REFERENCE TO THE RELATED APPLICATIONS

This is an application filed pursuant to 35 U.S.C. Section 111(a) with claiming the benefit of U.S. Provisional application Ser. No. 60/607,593 filed Sep. 8, 2004 and No. 60/607,594 filed Sep. 8, 2004 under the provision of 35U.S.C. Section 111(b), pursuant to 35 U.S.C. Section 119(e)(1).

### TECHNICAL FIELD

The present invention relates to electrically conductive composites with resin (hereinafter referred to simply as a conductive composites with resin) containing vapor grown carbon fiber (VGCF) serving as an electrically conductive filler (hereinafter referred to simply as a conductive filler) and to a method for producing the composition. More particularly, the invention relates to conductive composites with resin which exhibit conductivity higher than that of conventional conductive composites with resin and VGCF in an amount equivalent to a conventional amount, or which exhibit conductivity equal to or higher than that of a conventional conductive composites with resin and VGCF in an amount smaller than a conventional amount, and to a method for producing the composites.

### BACKGROUND ART

Conventionally, properties such as conductivity and antistatic characteristics have long been imparted to a thermoplastic resin, which is an electrically insulating material, through incorporation of a conductive filler into the resin, and a variety of conductive fillers have been employed for this purpose. Examples of generally employed conductive fillers include carbon-based materials having a graphite structure such as carbon black, graphite, vapor grown carbon fiber and carbon fiber; metallic materials such as metallic fiber, metallic powder and metallic foil; metallic oxides; and metal-coated inorganic fillers.

Among these conductive fillers, attempts have been made to utilize carbon-based conductive filler, since it is considered to exhibit excellent conductivity as well as satisfactory stability against atmospheric conditions (e.g., corrosion resistance), resistance to electric disorders caused by metallic powder, sliding characteristics (e.g., less wear of screws of a molding apparatus during molding), etc. The carbon-based conductive filler tends to be used in a wider variety of fields. In particular, in order to attain high conductivity through incorporation of a small amount of conductive filler, size reduction, increase in aspect ratio and specific surface area and other modification of conductive fillers have been found to be effective. Thus, methods have been employed such as reducing the fiber diameter or increasing the specific surface area of fibrous fillers (for example, Japanese Patent No. 2641712 (U.S. Pat. No. 4,663,230)) and utilization of carbon black and hollow carbon fibrils (carbon nanotubes) having a remarkably large specific surface area.

However, when the content of conductive filler is increased so as to attain high conductivity, melt fluidity of the aforementioned resin composition decreases, leading to difficulty in molding and readily causing short shot. Even if molding is completed, the molded products may be unsatisfactory ones with poor surface appearance or variations in mass per shot. And only the molded products inferior in mechanical property such as impact strength may be produced.

Meanwhile, in order to enhance conductivity of a filler material itself, attempts have been made to enhance conductivity of the filler (Japanese Patent Application Laid-Open (kokai) No. 2001-200096).

In an attempt to lower the conductive filler content (percolation threshold value), at which conductivity drastically becomes high and stable by virtue of formation of a conductive network of the conductive filler in the resin composition, mainly the following three approaches have been studied.

i) Studies on Effect of Morphology of Conductive Filler

The studies have elucidated that the threshold value can be lowered through reduction in size of conductive filler, increase in aspect ratio of the filler or increase in surface area of the filler.

ii) Studies on a Polymer Blending Technique

With respect to a blended resin having an islands-in-the-sea microstructure or a mutually continuous microstructure, there has been proposed a method for forming a mixture of conductive resin by incorporating carbon black uniformly into the sea phase (i.e., matrix phase or continuous phase) resin having affinity with carbon black at high concentration and density (Japanese Patent Application Laid-Open (kokai) No. 2-201811). Another method has been proposed for forming a conductive plastic by incorporating vapor grown carbon fiber uniformly into the sea phase (i.e., matrix phase or continuous phase) resin having affinity with vapor grown carbon fiber at high concentration and density (Japanese Patent Application Laid-Open (kokai) No. 1-263156).

iii) An Approach To Elevate Interfacial Energy

It has been elucidated that the higher the interfacial energy, the threshold value of a composite of any of various resins and carbon black decreases (e.g., the percolation threshold value is lower in the case of polypropylene/carbon black than in the case of nylon/carbon black) (Masao SUMITA, Journal of the Adhesion Society of Japan, 1987, Vol. 23, P. 103). When carbon black is employed as a conductive filler, there has been made an attempt to elevate the interfacial energy between carbon black and resin by elevating the surface energy of carbon black through oxidation treatment.

Extensive studies have been carried out as mentioned above, to thereby make steady improvement to lower the threshold value through elevating conductivity of conductive filler, by means of the polymer blending method, and other methods. However, the polymer blending method cannot be employed in the case where a change in intrinsic properties of a starting materials caused by blending of polymers is not acceptable. When the size of conductive filler is reduced or the aspect ratio or the surface area of the filler is increased, fluidity of the resin composition during molding is impaired. The effect of the method for lowering the threshold value by elevating the interfacial energy is not very remarkable. In this way, there still remain problems such as deterioration of physical properties, lowering of fluidity during molding and poor appearance of molded products, for attaining high conductivity of a resin composition including a single kind of resin.

Specifically, with a trend of reducing size and weight of office automation (OA) apparatus and electronic apparatus, as well as attaining higher integration and precision, the marketing needs are increasing for conductive resin to reduce adhesion of dust on electric/electronic parts to the least possible degree. The needs have been growing for greater sophistication and diversity year by year.

For example, there have raised an increasing number of exact requirements for IC chips used in semiconductor elements, wafers, interior parts employed in computer hard disks, etc., and adhesion of dust on these parts must be completely prevented by imparting antistatic properties to the parts. For such applications, there have been employed conductive composites with resin, in which a conductive filler such as carbon black is incorporated to a polymer alloy predominantly containing polycarbonate resin (blend of polycarbonate resin with ABS resin) or a polymer alloy predominantly containing polyphenylene ether resin (blend of polyphenylene ether resin with polystyrene resin). In order to attain high conductivity, a large amount of carbon black must be incorporated into a resin, resulting in a problem of decrease in mechanical strength and fluidity of conductive resin.

“Electrostatic coating” is carried out in painting automobile outer parts by passing an electric current through conductivity-imparted resin molded products and spraying a paint which is charged oppositely to the part to be painted. The electrostatic coating is a technique which enhances adhesion of a paint on the surface of molded products by taking advantage of the nature of the charges on the surface and opposite charges in the paint attracting to each other. Many exterior panels and parts of automobiles are formed of a blend of polycarbonate resin and polyester resin or a blend of polyphenylene ether and polyamide resin. When a conductive filler is incorporated into these molding resin materials for imparting conductivity, it results in a problem of decrease in mechanical strength and fluidity thereof.

However, carbon black and carbon nanotubes have a remarkably large specific surface area (specific surface area: 800 m²/g (carbon black) and 250 m²/g (carbon nanotubes)). In other words, carbon black and carbon nanotubes have a large aggregation energy per unit mass, and therefore, when these materials are incorporated into resin, aggregation power in molten resin increases, requiring high shear force for uniformly dispersing the carbon materials in the molten resin. During dispersion, carbon nanotubes may be broken and aggregation of carbon filaments may occur. Thus, when such carbon materials are employed, stable conductivity is very difficult to attain.

Generally, vapor grown carbon fiber having large aspect ratio and specific surface area for attaining high conductivity has a small bulk density (less than 0.04 g/cm³); i.e., a huge volume per mass. When such carbon fiber serving as a filler is fed to an extruder, the carbon fiber is not entangled with the extruder very well, which obstructs uniform dispersion of the carbon fiber in the resin.

To overcome this problem, methods for increasing the bulk density such a compression method (Japanese Patent Application Laid-Open (kokai) No. 2-248440) and a method employing a granulation enhancer (Japanese Patent Application Laid-Open (kokai) No. 4-24259) have been disclosed. Through employment of any of these methods, the problem involved in the extrusion step is mitigated. However, the conductivity of the resin compositions has not been improved satisfactorily.

### DISCLOSURE OF THE INVENTION

An object of the present invention is to form a stable conductive network through addition of a very small amount of a conductive filler, and more specifically, to provide a conductive plastic in which a conductive filler is dispersed in a polymer; inter alia, a plastic product which contains a conductive filler in an amount equivalent to the conventional amount and yet exhibits higher conductivity or a plastic product which contains a smaller amount of a conductive filler and yet exhibits conductivity equivalent to or higher than the conventionally attained conductivity, and a composition which exhibits stable conductivity and less deterioration in physical properties during any molding methods.

The present inventors have conducted extensive studies on the melt-kneading method which minimizes breakage of carbon fiber and enables uniform dispersion of carbon fiber, in order to form a stable conductive network through addition of a small amount of vapor grown carbon fiber, and have found that when a specific vapor grown carbon fiber is kneaded with a molten resin, the vapor grown fiber can be uniformly dispersed in the molten resin causing no aggregation of filaments of the vapor grown carbon fiber. The present invention has been accomplished on the basis of this finding.

Accordingly, the present invention relates to the following conductive composites with resin, a method for producing the same, and use of the same.

1. Conductive composites with resin produced by mixing a vapor grown carbon fiber having a fiber diameter of 2 to 500 nm with a matrix resin in a molten state while suppressing breakage of the fiber 20% or less.

2. The conductive composites with resin as described in 1 above, wherein the vapor grown carbon fiber has an aspect ratio of 10 to 1,000.

3. The conductive composites with resin as described in 1 above, wherein the vapor grown carbon fiber has a mean fiber diameter of 10 to 200 nm.

4. The conductive composites with resin as described in any of 1 to 3 above, wherein the vapor grown carbon fiber is contained in an amount of 1 to 70 mass %.

5. The conductive composites with resin as described in 1 above, wherein the matrix resin is at least one species selected from thermoplastic resin and thermosetting resin.

6. The conductive composites with resin as described in 1 above, wherein the breakage of the fiber during the melt-mixing is 15% or less.

7. The conductive composites with resin as described in 1 above, wherein the vapor grown carbon fiber has a bulk density of 0.04 to 0.1 g/cm³.

8. The conductive composites with resin as described in 1 above, wherein the vapor grown carbon fiber is formed by press-molding a vapor grown carbon fiber product having a fiber diameter of 2 to 500 nm, heating the compressed product at 1,000° C. or higher in an inert gas atmosphere and crushing the heated product so as to adjust the bulk density of the fiber to 0.04 to 0.1 g/cm³.

9. The conductive composites with resin as described in 7 above, which contain a vapor grown carbon fiber in an amount of 5 mass % or less and have a volume resistivity of 1×10⁷ Ωcm or less.

10. A method for producing conductive composites with resin produced by mixing a vapor grown carbon fiber having a fiber diameter of 2 to 500 nm with a matrix resin in a molten state while suppressing breakage of the fiber 20% or less.

11. The method for producing conductive composites with resin as described in 10 above, wherein the melt-mixing is performed while monitoring the mixture under an electron microscope so as not to generate an aggregated mass of vapor grown carbon fiber.

12. The method for producing conductive composites with resin as described in 10 above, wherein melt-mixing is performed by means of a co-rotating twin-screw extruder and the vapor grown carbon fiber is fed to the extruder by way of side feeding.

13. The method for producing conductive composites with resin as described in 10 above, wherein melt-mixing is performed by means of a batch-type pressure kneader and vapor grown carbon fiber is fed to the matrix resin which has been melted in the kneader in advance.

14. A synthetic resin molded article comprising the conductive composites with resin as described in 1 above.

15. A container for electric and electronic parts comprising the conductive composites with resin as described in 1 above.

The present invention also relates to the following conductive composites with resin, a method for producing the same, and use of the same.

16. A conductive composites with resin, comprising a vapor grown carbon fiber having a fiber diameter of 5 to 500 nm and a bulk density of 0.04 to 0.1 g/cm³ melt-kneaded in a matrix resin.

17. The conductive composites with resin as described in 16 above, wherein the vapor grown carbon fiber is formed by press-molding a vapor grown carbon fiber product having a fiber diameter of 5 to 500 nm, heating the compressed product at 1,000° C. or higher in an inert gas atmosphere and crushing the heated product so as to adjust the bulk density of the fiber to 0.04 to 0.1 g/cm³.

18. The conductive composites with resin as described in 16 or 17 above, wherein the vapor grown carbon fiber has an aspect ratio of 50 to 1,000.

19. The conductive composites with resin as described in any of 16 to 18 above, wherein the vapor grown carbon fiber is contained in an amount of 3 to 70 mass %.

20. The conductive composites with resin as described in any of 16 to 19 above, wherein the vapor grown carbon fiber has a mean fiber diameter of 10 to 200 nm.

21. The conductive composites with resin as described in any of 16 to 20 above, wherein the matrix resin is at least one species selected from thermoplastic resin and thermosetting resin.

22. The conductive composites with resin as described in any of 16 to 21 above, wherein the vapor grown carbon fiber, after melt-mixing, has a breakage rate of 20% or less.

23. The conductive composites with resin as described in any of 16 to 22 above, which contain a vapor grown carbon fiber in an amount of 5 mass % or less and have a volume resistivity of 1×10⁷ Ωcm or less.

24. A method for producing the conductive composites with resin as described in any of 16 to 23 above, comprising melt-mixing a vapor grown carbon fiber with a matrix resin, characterized in that breakage rate of the vapor grown carbon fiber is suppressed to 20% or less during melt-mixing.

25. The method for producing a conductive composites with resin as described in 24 above, wherein melt-mixing is performed by means of a co-rotating twin-screw extruder or a pressure kneader.

26. A synthetic resin molded article comprising the conductive composites with resin as described in any of 16 to 23 above.

27. A container for electric and electronic parts comprising the conductive composites with resin as described in any of 16 to 23 above.

Since carbon nanotubes have a large aggregation energy, high shear force is required to knead resin with carbon nanotubes. Thus, during dispersion, carbon nanotubes may be broken and aggregation of carbon filaments may occur, which makes it difficult to attain stable conductivity. In contrast, according to the present invention, a specific vapor grown carbon fiber is fed to a matrix resin in a molten state, to thereby uniformly disperse the vapor grown carbon fiber in a minimum required amount in the matrix resin, whereby a stable conductive network is formed. Thus, the invention is highly valuable in the industrial field. Moreover, by using a vapor grown carbon fiber adjusted to have a specific bulk density, the conductivity of the resin composition can be further enhanced.

The conductive composites with resin of the present invention prevent release of carbon microparticles from molded articles, maintain impact characteristics of resin per se, and attain high conductivity, excellent sliding-related properties, high thermal conductivity, high strength, high elastic modulus, high fluidity during molding and high surface flatness of molded articles.

Molded articles of the conductive composites with resin are excellent in terms of mechanical strength, easiness of coating, thermal stability and impact strength as well as excellent conductivity and antistatic performance. Thus, such articles can be advantageously used in a variety of fields such as transportation of electric/electronic parts, parts for packaging used in the electric/electronic industry, parts for OA apparatuses, and automobile parts to be coated through static coating.

### BEST MODE FOR CARRYING OUT THE INVENTION

The vapor grown carbon fiber employed in the present invention has a fiber diameter of 2 to 500 nm, preferably 3 to 200 nm.

The vapor grown carbon fiber preferably has the following physical properties.

Aspect ratio: 10 to 1,000, preferably 65 to 300, more preferably 80 to 200. In general, impact strength increases with aspect ratio. However, when the aspect ratio exceeds 1,000, fiber filaments are entangled with one another, thereby in some cases causing decrease in conductivity, fluidity during molding and impact strength, whereas when the aspect ratio is less than 10, the vapor grown carbon fiber does not sufficiently improve the conductivity of the resin containing the fiber.

Specific surface area: 2 to 1,000 m²/g, preferably 5 to 500 m²/g, more preferably 10 to 250 m²/g.

A mean fiber diameter: 10 to 200 nm, more preferably 15 to 170 nm, particularly preferably 70 to 140 nm.

The thus-produced vapor grown carbon fiber may be used without performing any further treatment. Alternatively, the produced vapor grown carbon fiber subjected to heat treatment at 800 to 1,500° C. or graphitizing treatment at 2,000 to 3,000° C. may be employed.

The vapor grown carbon fiber employed in the present invention is preferably adjusted to have a bulk density of 0.04 to 0.1 g/cm³, more preferably 0.04 to 0.08 g/cm³. When the bulk density is less than 0.04 g/cm³, conductivity of the resin composite material containing such carbon fiber cannot be fully enhanced, whereas when the bulk density exceeds 0.1 g/cm³, high shear force is required for pulverizing aggregated masses, resulting in breakage of fiber filaments. In this case, conductivity is rather reduced.

In the present invention, the method of adjusting bulk density of the carbon fiber is also a critical issue. In a suitable method for adjusting bulk density, vapor grown fiber filaments appropriately cohere to each other in the absence of an additional impurity for cohesion. Specifically, in one preferred method, the reaction product of (as-grown) vapor grown carbon fiber having a fiber diameter of 2 to 500 nm is press-molded and heated at 1,000° C. or higher in an inert gas atmosphere, followed by crushing the product such that the bulk density is adjusted to 0.04 to 0.1 g/cm³. By adjusting bulk density using such a method, conductivity of the resin composite material containing the carbon fiber can be further enhanced. The heat treatment may be baking at 1,000 to 1,500° C. or graphitization at 2,000 to 3,000° C. These treatment may be performed in combination.

In the case in which the bulk density of the as-grown vapor grown carbon fiber is adjusted only by press-molding, conductivity of the resin composite material containing the carbon fiber may fail to be enhanced, even though the bulk density falls within the aforementioned range. In the case in which the bulk density of the as-grown vapor grown carbon fiber is adjusted by granulation of the carbon fiber using a binder compound such as stearic acid, conductivity of the resin composite material containing the carbon fiber may be impaired, even though the bulk density falls within the aforementioned range.

The vapor grown carbon fiber employed in the present invention may be produced by, for example, feeding a gasified organic compound with iron serving as a catalyst into an inert atmosphere at high-temperature (see, for example, Japanese Patent Application Laid-Open (kokai) No. 7-150419).

No particular limitation is imposed on the matrix resin employed in the present invention, and either thermosetting resin or thermoplastic resin may be employed, and the matrix preferably exhibits low viscosity during molding. Examples of preferred resins include engineering plastics, super-engineering plastics, low-molecular-weight plastics and thermosetting resins. High-molecular weight plastics are also preferably employed, so long as molding can be performed at higher temperature for reducing viscosity.

No particular limitation is imposed on the thermoplastic resin, and any moldable thermoplastic resins can be employed. Examples include polyesters such as polyethylene terephthalate (PET), polybutylene terephthalate (PBT), polytrimethylene terephthalate (PTT), polyethylene naphthalate (PEN), and liquid crystal polyester (LCP); polyolefins such as polyethylene (PE), polypropylene (PP), polybutene-1 (PB-1) and polybutylene; styrene resins; polyoxymethylene (POM); polyamides (PA); polycarbonates (PC); poly(methyl methacrylate) (PMMA); poly(vinyl chloride) (PVC); polyphenylene ether (PPE); polyphenylene sulfide (PPS); polyimides (PI); polyamide-imides (PAI); polyether-imides (PEI); polysulfones (PSU); polyether-sulfones; polyketones (PK); polyether-ketones (PEK); polyether-ether-ketones (PEEK); polyether-ketone-ketones (PEKK); polyarylates (PAR); polyether-nitriles (PEN); phenol (e.g., novolak) phenoxy resins; and fluorine-containing resins such as polytetrafluoroethylene (PTFE). Examples further includes thermoplastic elastomers such as polystyrene-, polyolefin-, polyurethane-, polyester-, polyamide-, polybutadiene-, polyisoprene-, or fluorine-containing elastomers; copolymers thereof; modified products thereof; and blends of two or more species thereof.

In order to enhance impact resistance, other elastomer or rubber components may be added to the aforementioned thermoplastic resins. Examples of the elastomers include olefin elastomers such as EPR and EPDM, styrene elastomer such as SBR i.e. styrene-butadiene copolymer, silicone elastomer, nitrile elastomer, butadiene elastomer, urethane elastomer, nylon elastomer, ester elastomer, fluororesin elastomer, natural rubber, and modified product thereof to which a reactive site (e.g., double bond, carboxylic acid anhydride moiety) is introduced.

No particular limitation is imposed on the thermosetting resin, and any thermosetting resin used in molding can be employed. Examples include unsaturated polyester resins, vinyl ester resins, epoxy resins, phenol (resol) resins, urea-melamine resins and polyimide resins; copolymers thereof; modifies products thereof; and combinations of two or more species thereof. In order to enhance impact resistance, an elastomer or a rubber component may be added to the aforementioned thermosetting resins.

The vapor grown carbon fiber content in the conductive composites with resin is 1 to 70 mass %, preferably 3 to 60 mass %, more preferably 3 to 50 mass %.

Into the conductive composites with resin of the present invention, a variety of other resin additives may be incorporated, so long as effects or achievement of objectives of the present invention are not affected. Examples of the resin additives which may be incorporated into the composition include a colorant, a plasticizer, a lubricant, a heat stabilizer, a photo-stabilizer, a UV-absorber, a filler, a foaming agent, a flame retardant and an anti-corrosive agent. These resin additives are preferably incorporated at a final stage of preparation of the conductive composites with resin of the present invention.

The conductive composites with resin of the present invention can be produced by mixing a vapor grown carbon fiber having a fiber diameter of 2 to 500 nm, preferably 3 to 200 nm with a matrix resin in a molten state. Through addition of a vapor grown carbon fiber to a matrix resin in a molten state, followed by mixing, the vapor grown carbon fiber is well dispersed in the resin, whereby a conductive network can be formed.

In the present invention, during mixing and kneading components for forming the conductive composites with resin, breakage of the vapor grown carbon fiber is preferably suppressed to a minimum possible level. Specifically, the breakage rate of vapor grown carbon fiber is preferably controlled to 20% or less, more preferably 15% or less, particularly preferably 10% or less. The breakage rate may be evaluated through comparison of aspect ratio before and after mixing/kneading (e.g., from an electron microscopic (SEM) image).

In order to perform mixing/kneading with suppressing breakage of the vapor grown carbon fiber to a minimum possible level, the following method may be employed.

Generally, when a thermoplastic resin or a thermosetting resin is melt-kneaded with an inorganic filler, high shear force is applied to aggregated inorganic filer filaments, thereby breaking the inorganic filler to form minute fragments, whereby the inorganic filer is uniformly dispersed in a molten resin. In order to generate such high shear force, a variety of kneaders are employed. Examples include a kneader based on a stone mill mechanism and a co-rotating twin-screw extruder having kneading disks in a screw element for applying high shear force. However, when such a type of kneader is employed, vapor grown carbon fiber is broken during the kneading step. If a singe-screw kneader generating weak shear force is employed, breakage of carbon fiber is prevented, but carbon fiber fails to be uniformly dispersed.

According to the present invention, a matrix resin is melted by means of a kneader, followed by uniformly feeding vapor grown carbon fiber to the surface of the molten resin. The mixture is subjected to dispersive mixing and distributive mixing, whereby the carbon fiber can be uniformly dispersed in the resin while breakage of the fiber is suppressed. In order to attain uniform dispersion of the carbon fiber while breakage of fiber is suppressed, a co-rotating twin-screw extruder having no kneading disk, a pressure kneader such as a batch-type which attains dispersion over a long period of time without applying high shear force, or a single-screw extruder having a specially designed mixing element may be employed.

In the case where the co-rotating twin-screw extruder is employed, resin is fed to the extruder through a hopper, and vapor grown carbon fiber is fed to the extruder by way of side feeding when the resin is sufficiently melted. In the case where a pressure kneader is employed, resin is placed in the kneader and sufficiently melted in advance, and vapor grown carbon fiber is fed to the molten resin.

If a matrix resin in a non-molten state and vapor grown carbon fiber are mixed, followed by kneading the mixture by melting the resin, high shear force is required for dispersing the carbon fiber in the resin. When high shear force is applied, the carbon fiber is broken, failing to form a sufficient conductive network.

In order to uniformly disperse vapor grown carbon fiber in a resin, wetting of the carbon fiber with molten resin is also a critical issue, and it is essential to increase the interfacial area between the molten resin and the vapor grown carbon fiber. In order to enhance wettability, the surface of vapor grown carbon fiber may be oxidized.

When the vapor grown carbon fiber employed in the present invention has a bulk density of about 0.01 to 0.1 g/cm³, the fiber is not dense and readily entrains air. In this case, degassing fiber is difficult when a conventional single-screw extruder and a co-rotating twin-screw extruder is employed, and thus it becomes difficult to charge the fiber into the kneader. In such a case, a batch-type pressure kneader is preferably employed in order to facilitate charging and suppress breakage of the carbon fiber to a minimum possible level. The thus-kneaded product obtained by use of a batch-type pressure kneader may be introduced into a single-screw extruder before solidification to be pelletized. As an extruder that can degas a vapor grown carbon fiber highly entraining air and allows large-amount charging, a reciprocal single-screw extruder (Co-kneader, product of Coperion Buss AG) may be employed.

The conductive composites with resin of the present invention have a volume resistivity of 10¹² to 10⁻³ Ω·cm, preferably to 10¹⁰ to 10⁻² Ω·cm, more preferably 10⁹ to 10⁻³ Ω·cm.

The conductive composites with resin of the present invention are suitably employed as a molding material for producing articles which require impact resistance and conductivity or antistatic property; e.g., OA apparatuses, electronic apparatuses, conductive packaging parts, antistatic packaging parts, and automobile parts to be coated through static coating. These articles may be produced through any conventionally known molding method of conductive composites with resin. Examples of the molding methods include injection molding, blow molding, extrusion, sheet molding, heat molding, rotational molding, lamination molding and transfer molding.

### EXAMPLES

The present invention will next be described in more detail by way of examples, which should not be construed as limiting the invention thereto.

### Examples 1 to 17 and Comparative Examples 1 to 13

According to the formulations shown in Tables 1 and 2, each composition was prepared by melt-kneading the resin and the conductive filler, and the kneaded product was injection-molded to thereby form plate pieces for volume resistivity measurement.

According to the formulations shown in Tables 3 and 4, each composition was prepared by melt-kneading the resin and the conductive filler, and the kneaded product was injection-molded to thereby form pieces for Izod impact test and plate pieces for volume resistivity measurement. The Izod impact test pieces were subjected to a cutting process, to thereby form notched Izod impact test pieces.

The resins, conductive fillers, kneading conditions, molding conditions and evaluation methods employed in the Examples are below-described in detail. Evaluation results of each Example and the Comparative Example are also shown in Tables 1 to 4.

[Synthetic Resins]

a) Thermoplastic Resin

Polycarbonate resin (PC) (Panlite L-1225L, product of Teijin Chemicals Ltd.)

b) Thermosetting Resin

Allyl ester resin (AA 101, product of Showa Denko K. K.) (viscosity 630,000 cps (30° C.)), in combination with dicumyl peroxide (Percumyl D, NOF Corporation) serving as an organic peroxide

[Vapor Grown Carbon Fiber]

a) VGCF (registered trademark): vapor grown carbon fiber, product of Showa Denko K.K. (mean fiber diameter: 150 nm, mean fiber length: 10 μm), was used.

b) VGCF-S: vapor grown carbon fiber, product of Showa Denko K.K. (mean fiber diameter: 100 nm, mean fiber length: 11 μm), was used.

c) VGNF (registered trademark): vapor grown carbon fiber, product of Showa Denko K.K. (mean fiber diameter: 80 nm, mean fiber length: 10 μm), was used.

d) VGNT (registered trademark): vapor grown carbon fiber, product of Showa Denko K.K. (mean fiber diameter: 20 nm, mean fiber length: 10 μm), was used.

[Kneading Method]

a) Thermoplastic Resin

(a-1) Co-Rotating Twin-Screw Extruder

Kneading was performed so as to incorporate vapor grown carbon fiber into resin by use of a co-rotating twin-screw extruder (PCM 30, not equipped with a kneading disk, product of Ikegai Corporation) at an L/D of 30 and a kneading temperature of 280° C. under the following conditions (i) or (ii).

Condition (i): Resin was melted, followed by feeding vapor grown carbon fiber thereto by way of side feeding.

Condition (ii): Resin pellets and vapor grown carbon fiber were fed at once through a hopper.

[B0034]

(a-2) Laboplast Mill (Batch-Type Pressure Kneader)

Kneading was performed so as to incorporate vapor grown carbon fiber into resin by use of a kneader (Laboplast mill, capacity of 100 cm³, product of Toyo Seiki) at 80 rpm and a kneading temperature of 280° C. under the following conditions (i) or (ii).

Condition (i): Resin was completely melted, followed by feeding vapor grown carbon fiber to the molten resin. The mixture was kneaded for 10 minutes.

Condition (ii): Resin pellets and vapor grown carbon fiber were fed at once through a hopper, and the mixture was kneaded for 20 minutes.

[A0040]

b) Thermosetting Resin

Kneading was performed by use of a pressure kneader (product of Toshin Co., Ltd., kneading capacity: 10 L) at 60° C.

[Molding Method]

a) Thermoplastic Resin

Each thermoplastic resin was molded into plate test pieces (100×100×2 mm (thickness)) by means of an injection molding machine (Sicap, clamping force: 75 tons, product of Sumitomo Heavy Industries, Ltd.) at molding temperature of 280° C. and a mold temperature of 130° C. Notched Izod test pieces were obtained through a cutting process.

b) Thermosetting Resin

Each thermosetting resin was molded into test pieces (Izod test pieces (ASTM D256-compliant) and plates (100×100×2 mm (thickness)) by means of an injection-molding apparatus (M-70C-TS, product of Meiki Co., Ltd.) at molding temperature of 120° C. and a mold temperature of 150° C. Notched Izod test pieces were obtained through a cutting process.

[Method for Adjusting Bulk Density of Conductive Filler]

a) Each as-grown carbon fiber was press-molded and graphitized at 2,800° C., followed by crushing, whereby bulk density was adjusted.

b) Bulk density was adjusted only by press-molding.

c) Each carbon fiber was granulated at 100° C. by use of stearic acid in a Henschel mixer, to thereby adjust bulk density.

[Determination of Physical Properties]

a) Notched Izod impact value: Determined in accordance with ASTM D256.

b) Volume resistivity: Measured in accordance with JIS K7194, through the 4-probe method.

c) Bulk density: Each conductive filler (1 g) was placed in a messcylinder (100 cm³) and shaken for one minute. After stirring, the conductive filler was shaken again for 30 seconds. The volume was determined, to thereby calculate the bulk density.

d) Aggregated mass of carbon fiber filaments:

A broken plane of strands obtained by kneading by means of a co-rotating twin-screw extruder was observed under an electron microscope (SEM) (×2,000). In the case where a Laboplast mill was employed, a melt-kneaded resin composite mass was melt-pressed at 280° C., and a broken plane feature of the mass was observed. The presence of a filament-aggregated mass was evaluated as follows according to the size (longer diameter) of an aggregated mass:

◯: smaller than 0.5 μm

Δ: 0.5 to 5 μm (not inclusive)

X: 5 μm or more

e) Breakage rate (%) of carbon fiber: determined from the following equation:
Breakage rate (%) of carbon fiber={1−(carbon fiber aspect ratio in molded article/carbon fiber aspect ratio before mixing/kneading)}×100,

wherein each aspect ratio was measured through observation under an electron microscope (SEM), followed by calculation.

TABLE 1

| | | | | | | | Volume | | |
|---|---|---|---|---|---|---|---|---|---|
| | | Amount | Conductive | Amount | Type of | Kneading | resistivity | Aggregated | Breakage |
| Ex. | Resin | mass % | filler | mass % | kneader | conditions | Ω · cm | mass | rate % |
| 1 | PC | 95 | VGCF-S | 5 | Twin-screw | i | 4.0 × 10⁸ | ◯ | 4 |
| | | | | | kneader* | | | | |
| 2 | PC | 95 | VGNF | 5 | Laboplast | i | 1.0 × 10⁸ | ◯ | 6 |
| | | | | | mill | | | | |
| 3 | PC | 95 | VGNT | 5 | Laboplast | i | 8.0 × 10⁷ | ◯ | 8 |
| | | | | | mill | | | | |
| 4 | PC | 90 | VGCF-S | 10 | Twin-screw | i | 5.0 × 10³ | ◯ | 8 |
| | | | | | kneader* | | | | |
| 5 | PC | 80 | VGCF | 20 | Twin-screw | i | 5.0 × 10⁴ | ◯ | 3 |
| | | | | | kneader* | | | | |
| 6 | PC | 40 | VGCF | 60 | Laboplast | i | 2.0 × 10⁻¹ | ◯ | 10 |
| | | | | | mill | | | | |

Co-rotating twin-screw extruder

TABLE 2

| | | | | | | | Volume | | |
|---|---|---|---|---|---|---|---|---|---|
| Comp. | | Amount | Conductive | Amount | Type of | Kneading | resistivity | Aggregated | Breakage |
| Ex. | Resin | mass % | filler | mass % | kneader | conditions | Ω · cm | mass | rate % |
| 1 | PC | 95 | VGCF-S | 5 | Twin-screw | ii | 2.0 × 10¹² | Δ | 15 |
| | | | | | kneader* | | | | |
| 2 | PC | 95 | VGNF | 5 | Laboplast | ii | 8.0 × 10¹⁵ | Δ | 25 |
| | | | | | mill | | | | |
| 3 | PC | 95 | VGNT | 5 | Laboplast | ii | 4.0 × 10¹⁵ | X | 30 |
| | | | | | mill | | | | |
| 4 | PC | 90 | VGCF-S | 10 | Twin-screw | ii | 3.0 × 10⁹ | Δ | 20 |
| | | | | | kneader* | | | | |
| 5 | PC | 80 | VGCF | 20 | Twin-screw | ii | 4.0 × 10⁶ | ◯ | 20 |
| | | | | | kneader* | | | | |
| 6 | PC | 40 | VGCF | 60 | Laboplast | ii | 5.0 × 10⁰ | ◯ | 30 |
| | | | | | mill | | | | |

*Co-rotating twin-screw extruder

TABLE 3

| | | | | | | Method for | | | |
|---|---|---|---|---|---|---|---|---|---|
| | | | | | Bulk | adjusting | Volume | Izod | |
| | | Amount | Conductive | Amount | density | bulk | resistivity | impact | Breakage |
| Ex. | Resin | mass % | filler | mass % | g/cm³ | density | Ω · cm | J/m | rate % |
| 7 | PC | 95 | VGCF-S | 5 | 0.04 | a | 4.0 × 10⁶ | 125 | 4 |
| 8 | PC | 95 | VGCF-S | 5 | 0.1 | a | 6.0 × 10⁵ | 120 | 3 |
| 9 | PC | 95 | VGNF | 5 | 0.04 | a | 2.0 × 10⁶ | 115 | 8 |
| 10 | PC | 95 | VGNT | 5 | 0.04 | a | 6.0 × 10⁵ | 110 | 15 |
| 11 | PC | 90 | VGCF-S | 10 | 0.04 | a | 2.0 × 10³ | 80 | 5 |
| 12 | PC | 80 | VGCF | 20 | 0.04 | a | 2.0 × 10³ | 50 | 5 |
| 13 | PC | 40 | VGCF | 60 | 0.04 | a | 3.0 × 10⁻² | 30 | 15 |
| 14 | Allyl | 95 | VGCF-S | 5 | 0.04 | a | 6.0 × 10³ | 120 | 2 |
| | ester | | | | | | | | |
| 15 | Allyl | 95 | VGNF | 5 | 0.04 | a | 5.0 × 10³ | 95 | 4 |
| | ester | | | | | | | | |
| 16 | Allyl | 80 | VGCF | 20 | 0.04 | a | 3.0 × 10⁰ | 120 | 5 |
| | ester | | | | | | | | |
| 17 | Allyl | 40 | VGCF | 60 | 0.04 | a | 2.0 × 10⁻² | 110 | 10 |
| | ester | | | | | | | | |

TABLE 4

| | | | | | | Method for | | | |
|---|---|---|---|---|---|---|---|---|---|
| | | | | | Bulk | adjusting | Volume | Izod | |
| Comp. | | Amount | Conductive | Amount | density | bulk | resistivity | impact | Breakage |
| Ex. | Resin | mass % | filler | mass % | g/cm³ | density | Ω · cm | J/m | rate % |
| 7 | PC | 95 | VGCF-S | 5 | 0.02 | a | 4.0 × 10⁸ | 120 | 5 |
| 8 | PC | 95 | VGCF-S | 5 | 0.04 | b | 2.0 × 10⁸ | 120 | 5 |
| 9 | PC | 95 | VGCF-S | 5 | 0.06 | c | 1.0 × 10¹³ | 80 | 10 |
| 10 | PC | 95 | VGNF | 5 | 0.01 | a | 3.0 × 10⁸ | 115 | 20 |
| 11 | PC | 95 | VGNT | 5 | 0.01 | a | 5.0 × 10⁷ | 100 | 20 |
| 12 | PC | 20 | VGCF | 20 | 0.03 | a | 5.0 × 10⁴ | 50 | 5 |
| 13 | Allyl | 95 | VGCF-S | 5 | 0.02 | a | 2.0 × 10⁴ | 115 | 4 |
| | ester | | | | | | | | |

1. Conductive composites with resin produced by mixing a vapor grown carbon fiber having a fiber diameter of 2 to 500 nm with a matrix resin in a molten state while suppressing breakage of the fiber 20% or less.

2. The conductive composites with resin as claimed in claim 1, wherein the vapor grown carbon fiber has an aspect ratio of 10 to 1,000.

3. The conductive composites with resin as claimed in claim 1, wherein the vapor grown carbon fiber has a mean fiber diameter of 10 to 200 nm.

4. The conductive composites with resin as claimed in claim 1, wherein the vapor grown carbon fiber is contained in an amount of 1 to 70 mass %.

5. The conductive composites with resin as claimed in claim 1, wherein the matrix resin is at least one species selected from thermoplastic resin and thermosetting resin.

6. The conductive composites with resin as claimed in claim 1, wherein the breakage of the fiber during the melt-mixing is 15% or less.

7. The conductive composites with resin as claimed in claim 1, wherein the vapor grown carbon fiber has a bulk density of 0.04 to 0.1 g/cm³.

8. The conductive composites with resin as claimed in claim 7, wherein the vapor grown carbon fiber is formed by press-molding a vapor grown carbon fiber product having a fiber diameter of 2 to 500 nm, heating the compressed product at 1,000° C. or higher in an inert gas atmosphere and crushing the heated product so as to adjust the bulk density of the fiber to 0.04 to 0.1 g/cm³.

9. The conductive composites with resin as claimed in claim 7, which contain a vapor grown carbon fiber in an amount of 5 mass % or less and have a volume resistivity of 1×10⁷ Ωcm or less.

10. A method for producing conductive composites with resin produced by mixing a vapor grown carbon fiber having a fiber diameter of 2 to 500 nm with a matrix resin in a molten state while suppressing breakage of the fiber 20% or less.

11. The method for producing conductive composites with resin as claimed in claim 10, wherein the melt-mixing is performed while monitoring the mixture under an electron microscope so as not to generate an aggregated mass of vapor grown carbon fiber.

12. The method for producing conductive composites with resin as claimed in claim 10, wherein melt-mixing is performed by means of a co-rotating twin-screw extruder and the vapor grown carbon fiber is fed to the extruder by way of side feeding.

13. The method for producing conductive composites with resin as claimed in claim 10, wherein melt-mixing is performed by means of a batch-type pressure kneader and vapor grown carbon fiber is fed to the matrix resin which has been melted in the kneader in advance.

14. A synthetic resin molded article comprising the conductive composites with resin as claimed in claim 1.

15. A container for electric and electronic parts comprising the conductive composites with resin as claimed in claim 1.
